(19) United States
(12) Patent Application Publication
(10) Pub. No.: US 2015/0046809 A1
(43) Pub. Date: Feb. 12, 2015

(54) ACTIVITY INDICATOR

(71) Applicant: Kobo Incorporated, Toronto (CA)

(72) Inventors: Anthony O'DONOGHUE, Toronto (CA); James WU, Toronto (CA)

(73) Assignee: Kobo Incorporated, Toronto (CA)

(21) Appl. No.: 14/105,611

(22) Filed: Dec. 13, 2013

Related U.S. Application Data
(63) Continuation-in-part of application No. 13/964,791, filed on Aug. 12, 2013.
Application No. 13/964,791 is a continuation-in-part of application No. 13/964,739, filed on Aug. 12, 2013.

(51) Int. Cl. G06F 3/0484; G06F 3/0488

(52) U.S. Cl. CPC G06F 3/0484; G06F 3/0488
USPC 715/716

(57) ABSTRACT

In accordance with a first method embodiment, a media content is displayed on a display screen. Information corresponding to other users' interaction with the media content is accessed. An activity indicator is displayed on the display screen. The activity indicator reflects a magnitude of the other users' interaction with the media content.

### RELATED APPLICATIONS

This application is a Continuation-in-Part (CIP) of co-pending, commonly owned U.S. patent application Ser. No. 13/964,791, filed Aug. 12, 2013, entitled “Presenting an Aggregation of Annotated Terms in eBook,” to O'Donoghue and Wu, which is hereby incorporated herein by reference in its entirety.

This application is a Continuation-in-Part (CIP) of co-pending, commonly owned U.S. patent application Ser. No. 13/964,739, filed Aug. 12, 2013, entitled “Presenting External Information Related to Preselected Terms in eBook,” to O'Donoghue and Wu, which is hereby incorporated herein by reference in its entirety.

This application is related to co-pending, commonly owned U.S. patent application Ser. No. 13/924,339, filed Jun. 21, 2013, entitled, “Determining Key eBook Terms for Presentation of Additional Information Related Thereto,” to Givoni, which is hereby incorporated herein by reference in its entirety.

### FIELD OF INVENTION

Embodiments of the present invention relate to the field of devices with electronic displays. More specifically, embodiments of the present invention relate to systems and methods for activity indicators.

### BACKGROUND

Viewing media content on e-reader devices, “eBooks,” or related applications on other types of computers, e.g., tablets or “smart” phones, is ubiquitous. Use of such devices for “social media” is perhaps more commonplace. However, viewing media content tends to isolate a user from social media, and also lacks the benefits of reading in a group, for example, a book club gathering.

### SUMMARY OF THE INVENTION

Therefore, what is needed are systems and methods for activity indictors that provide an enhanced user experience to a user. What is additionally needed are systems and methods for activity indictors that indicate a magnitude of other users interacting with the same media. A further need exists for systems and methods for activity indictors that are compatible and complementary with existing systems and methods of electronic device operation and usage. Embodiments of the present invention provide these advantages.

In accordance with a first method embodiment, a media content is displayed on a display screen. Information corresponding to other users' interaction with the media content is accessed. An activity indicator is displayed on the display screen. The activity indicator reflects a magnitude of the other users' interaction with the media content.

In accordance with another embodiment of the present invention, a computer system includes a processor, a network interface coupled to the processor, a display screen coupled to the processor and a memory coupled to the processor and the display screen. The computer system is configured to display a media content on the display screen, access information corresponding to other users' interaction with the media content, utilizing the network interface, and display on the display screen an activity indicator on the display screen. The activity indicator reflects a magnitude of the other users' interaction with the media content.

In accordance with a further embodiment of the present invention, an article of manufacture including a computer readable medium having instructions stored thereon that, responsive to execution by an electronic system, cause the electronic system to perform operations including displaying a media content on a display screen of the electronic system, accessing information corresponding to other users' interaction with the media content and displaying an activity indicator on the display screen, wherein the activity indicator reflects a magnitude of the other users' interaction with the media content.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1A illustrates an exemplary front view of a portable electronic system, which may be used as a platform to implement embodiments of the present invention.

FIG. 1B is an exemplary block diagram of an exemplary portable electronic system, which may be used as a platform to implement embodiments of the present invention.

FIG. 2 illustrates an exemplary portion of user interface displayed on display of a portable electronic system, in accordance with embodiments of the present invention.

FIG. 3 illustrates an exemplary display image displayed on a display of a portable electronic system, in accordance with embodiments of the present invention.

FIG. 4 illustrates an exemplary display image displayed on a display of a portable electronic system, in accordance with embodiments of the present invention.

FIG. 5 illustrates another exemplary display image displayed on a display of a portable electronic system, in accordance with embodiments of the present invention.

FIG. 6 illustrates yet another exemplary display image displayed on a display of a portable electronic system, in accordance with embodiments of the present invention.

FIG. 7 illustrates a method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., method 700) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “displaying” or “detecting” or “determining” or “setting” or “accessing” or “placing” or “testing” or “forming” or “mounting” or “removing” or “ceasing” or “stopping” or “coating” or “attaching” or “processing” or “performing” or “generating” or “adjusting” or “creating” or “executing” or “continuing” or “indexing” or “computing” or “translating” or “calculating” or “determining” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “picture element” or “pixel” is used to refer to or to describe the smallest portion of an electronic display that may be discriminated, e.g., directly addressed and/or controlled. For example, for a display described as having a resolution of 256 dots per inch (DPI), there are 256 pixels per inch.

As used herein, the term “icon” is used as understood by those of ordinary skill in the electronic arts. For example, an icon is generally understood to comprise an image displayed on a computer generated display that represents a specific file, e.g., an electronic book, audio or video file, directory, window, option or program, e.g., “app.” Selection of an icon, e.g., “clicking” with a mouse or touching an icon on a touch screen display, generally launches software appropriate for that specific file type. For example, selection of a “music file” icon will initiate an audio player software and play the particular music selection.

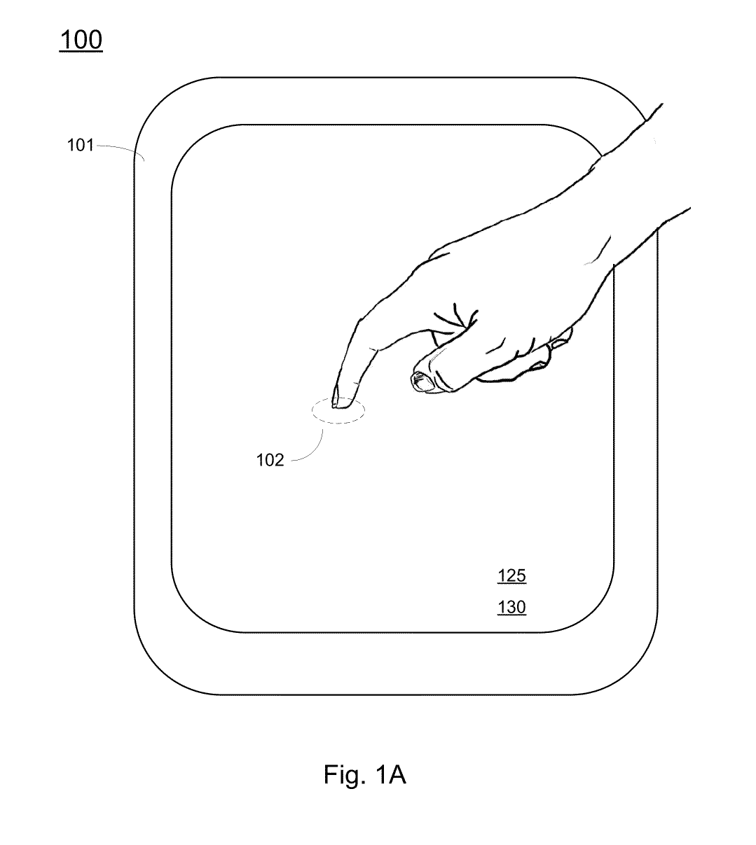

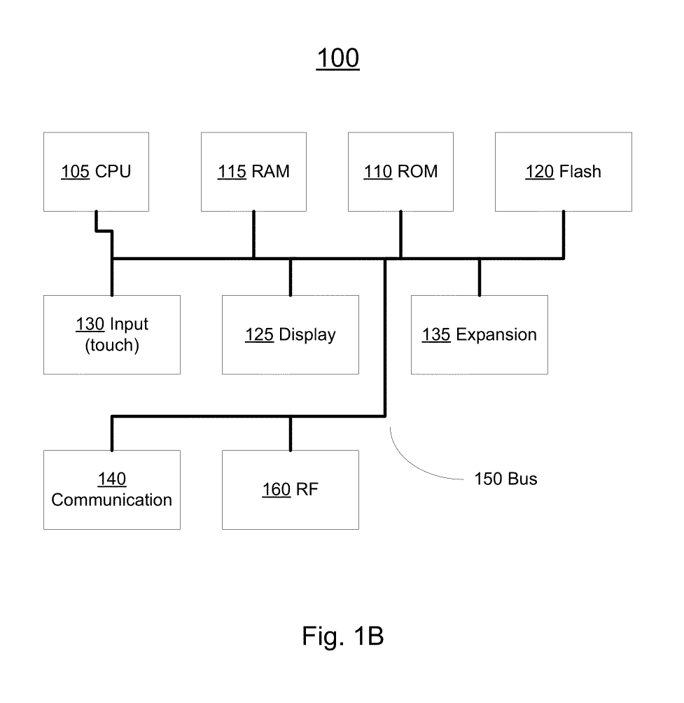

FIG. 1A illustrates an exemplary front view of a portable electronic system 100, which may be used as a platform to implement embodiments of the present invention. Portable electronic system 100 may comprise, for example, a “smart” phone, a tablet, and/or a personal digital assistant. Portable electronic system 100 may also comprise, for example, a “wearable” electronic system, including, e.g., a “smart” watch and/or glasses. Portable electronic system 100 is enclosed in a case or shell 101 of any suitable material. In some embodiments, various portions of portable electronic system 100 may be contained in multiple enclosures. For example, CPU 105 may be housed separately from display 125. Portable electronic system 100 comprises a display unit 125 and may comprise a touch sensitive digitizer panel 130, also known as or referred to as a “touch screen.” Touch sensitive digitizer panel 130 operates to indentify a point of contact 102 of a finger, stylus or other object. Item 102 may correspond to a cursor image on display 125, in some embodiments.

FIG. 1B is an exemplary block diagram of an exemplary portable electronic system 100, which may be used as a platform to implement embodiments of the present invention. Electronic system 100 may be battery-powered, in some embodiments. Electronic system 100 includes an address/data bus 150 for communicating information, a central processor 105 functionally coupled with the bus for processing information and instructions. Central processor 105 may comprise multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the portable electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a weapon-mounted and/or head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may consist of signals substantially compliant with the signals of bus 150.

A wide variety of well known devices may be attached to electronic system 100 via the bus 150 and/or expansion interface 135. Examples of such devices include without limitation rotating magnetic memory devices, flash memory devices, digital cameras, wireless communication modules, digital audio players and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of portable electronic system 100 may be implemented by a combination of hardware and/or software. Portable electronic system 100 may comprise additional software and/or hardware features (not shown) in some embodiments.

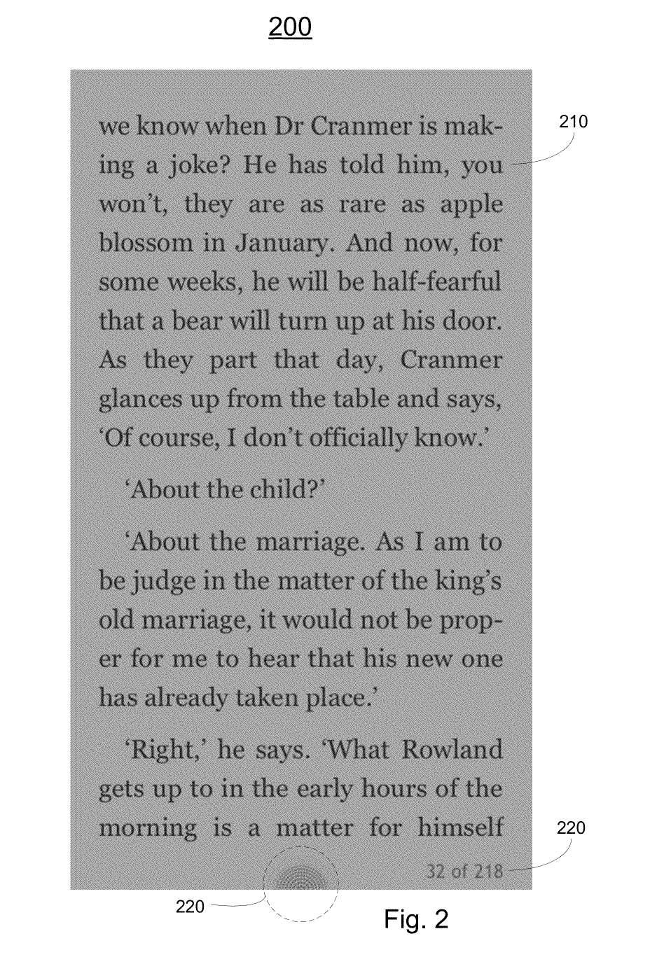

FIG. 2 illustrates an exemplary display image 200 displayed on display 125 of portable electronic system 100 (FIG. 1B), in accordance with embodiments of the present invention. Display image 200 may be presented as part of an e-book or e-reader application on a tablet or “smart” phone, for example. Display image 200 comprises subject text 210, page number information 220 and an exemplary activity indicator 230.

In accordance with embodiments of the present invention, an activity indicator, e.g., activity indicator 230, indicates an intensity level of a collection of users interacting with the same media, e.g., the same passage, page, chapter, book, series, or the like. As used herein, the term “interacting” is intended to include all manners of interaction than can be associated with, or performed on, a media. For example, “interacting” may include reading, discussing on social media, purchasing, downloading, “liking,” and the like.

An activity indicator may reflect a number of people interacting with the same media, e.g., a number of people reading, a number of downloads, a number of reader comments expressed, and the like. In general, the activity indicator may correspond to other users, e.g., utilizing other devices, which may be geographically dispersed, interacting with the same media. In some embodiments, other users may include different individuals using the same device, e.g., with different user identities.

For example, in one embodiment, an activity indicator indicates a number of users currently reading the same book, at substantially the same time. In another embodiment, an activity indicator indicates a cumulative number of users who have, at some time, read the same book and/or another book in a related series.

An activity indicator may take any suitable form. For example, an activity indicator, e.g., activity indicator 230, may comprise a series of semi-circles, a starburst design, overlapping and/or parallel diamond shapes, and the like. In some embodiments, an activity indicator is designed to be dissimilar to other common indicators, e.g., signal strength “bars.” An activity indicator is generally placed at the bottom of a display, although that is not required.

In some embodiments, an activity indicator may be dynamic, e.g., changing. An activity indicator may change size, shape, color, brightness or any other visual parameter in correlation with a number of users interacting with the media, or a number of comments about the media. For example, an activity indicator may increase in size as a number of other users interacting with the media increases, e.g., an activity indicator's size is positively correlated to a number of users interacting with the media. In some embodiments, an activity indicator may “breath,” e.g., fade in and out. Such dynamic changes may correspond to real time changes in an intensity level of a collection of users interacting with the same media. The visual attributes of an activity indicator need not be linearly related to the number of other users interacting with the media. For example, the relationship may be logarithmic.

For example, an activity indicator may “grow” in size as more users open a particular book, reflecting such an increase in a number of users interacting with the book. Similarly, an activity indicator may “grow” in size as more users comment on a particular book. In some embodiments, an activity indicator may decrease in size as a local user reads such comments. For example, an activity indicator indicates a number of unread comments.

In accordance with embodiments of the present invention, an activity indicator may change in relation to a context of the media. For example, an activity indicator may change when a user moves from a first chapter of a book to a second chapter of the book, indicating differences in other users' interaction with that media, e.g., more or fewer other users are reading the second chapter.

In accordance with embodiments of the present invention, the activity indicator may comprise a pulsating light, e.g., a light emitting diode (LED) and/or an electro-luminescent back light on the e-reader device, located within the display screen or on the device body, with rate of light pulsation corresponding to activity level.

In accordance with embodiments of the present invention, an activity indicator, e.g., activity indicator 230, may be an icon. For example, touching an activity indicator may cause an e-reader device to display additional information related to the reading material.

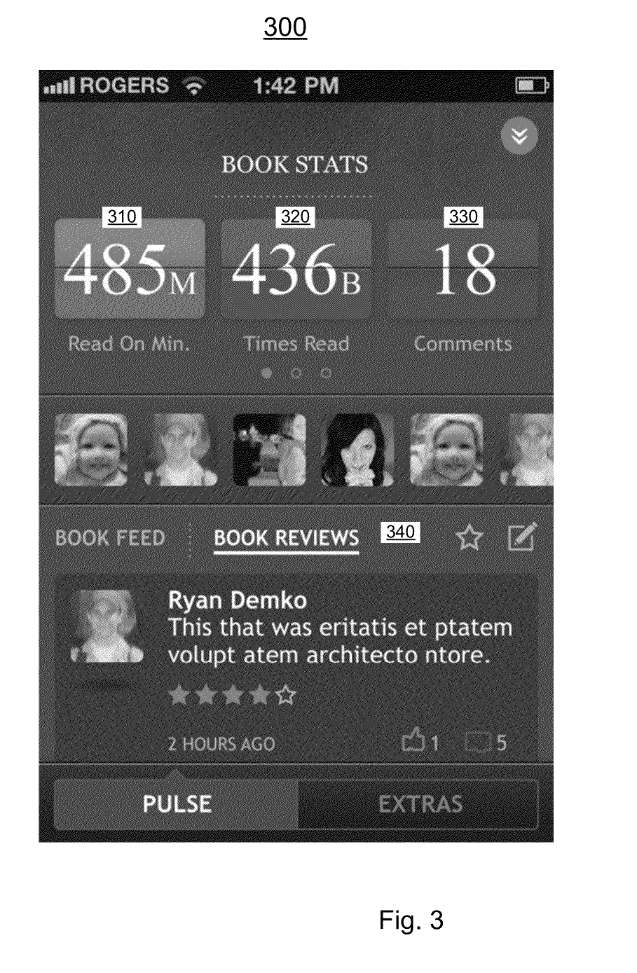

FIG. 3 illustrates an exemplary display image 300 displayed on display 125 of portable electronic system 100 (FIG. 1B), in accordance with embodiments of the present invention. Image 300 may be displayed responsive to touching an activity indicator. Image 300 displays a range of statistics related to a number of people interacting with the same media. For example, image 300 displays a total reading time 310, a number of times that the media has been read 320 and a number of comments 330 related to the media that have been posted to a social media. In addition, image 300 displays a list 340 of reviews related to the media. Display image 300 may display additional or alternative statistics related to other users' interaction with the media, including, for example, a total number of downloads for the media, a number of users current interacting with the same page or chapter, e.g., the same page or chapter displayed in image 200 of FIG. 2,

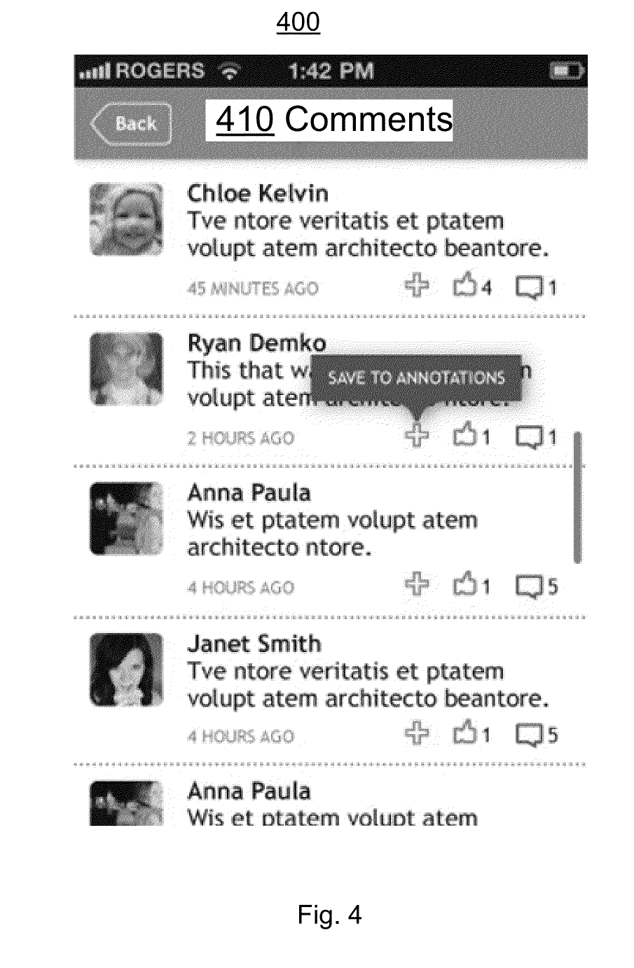

FIG. 4 illustrates an exemplary display image 400 displayed on display 125 of portable electronic system 100 (FIG. 1B), in accordance with embodiments of the present invention. Image 400 may be displayed responsive to activating or touching an activity indicator. Alternatively, image 400 may be displayed responsive to a touch indication on another screen image, e.g., image 300 of FIG. 3. Image 400 displays a list 410 of comments on the media, e.g., the same passage, page, chapter, book, series, or the like. Image 400 may be one of many displayable images, e.g., multiple pages, of such comments. It is appreciated that list 410 may be interactive, enabling a user to “plus” or “thumbs up” a comment, to reply to a comment, to view a thread related to a comment, or to save a comment for display with the media, in some embodiments.

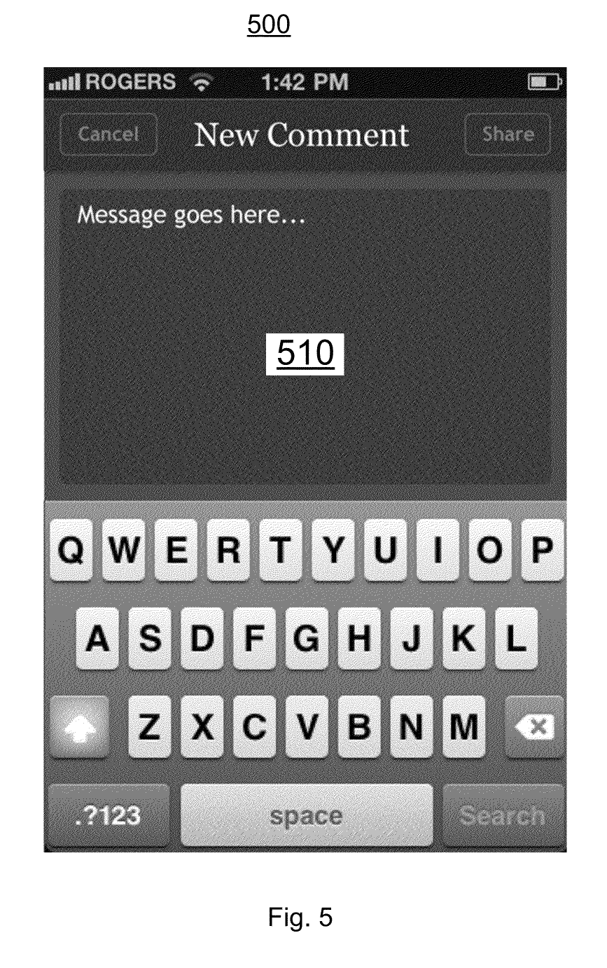

FIG. 5 illustrates an exemplary display image 500 displayed on display 125 of portable electronic system 100 (FIG. 1B), in accordance with embodiments of the present invention. Image 500 may be displayed responsive to activating or touching an activity indicator. Alternatively, image 500 may be displayed responsive to a touch indication on another screen image, e.g., image 300 of FIG. 3. Image 500 displays a dialog 510 for adding a new comment related to the media to a social media.

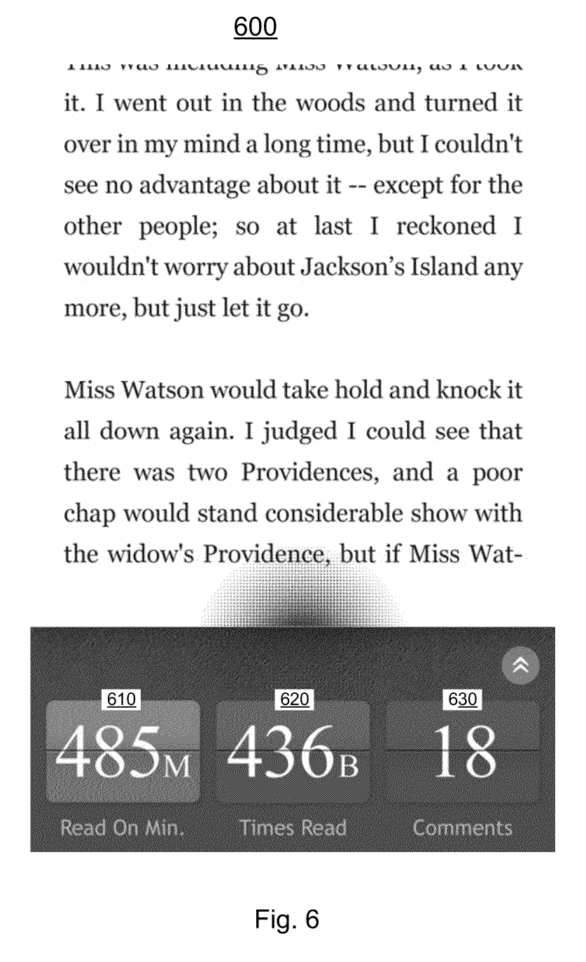

FIG. 6 illustrates an exemplary display image 600 displayed on display 125 of portable electronic system 100 (FIG. 1B), in accordance with embodiments of the present invention. Image 600 may be displayed responsive to activating or touching an activity indicator. Image 600 comprises an overlay or “pop up” modification 610 to a displayed image of a media. In this manner, much the present image of a media is maintained along with the presentation of addition interaction information, helping to place the interaction information in context with the media.

Such an overlay may display any information, including, for example, a total reading time 610, a number of times that the media has been read 620 and a number of comments 630 related to the media that have been posted to a social media.

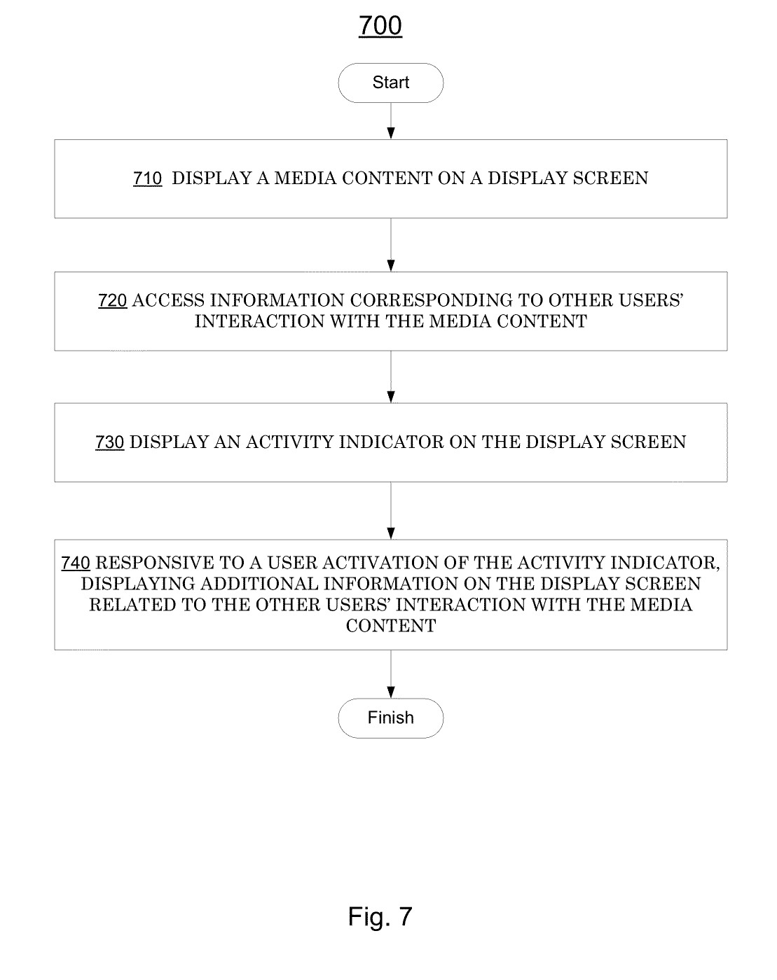

FIG. 7 illustrates a method 700, in accordance with embodiments of the present invention. Method 700, for example, may operate on portable electronic system 100 of FIGS. 1A and 1B.

In 710, a media content is displayed on a display screen, e.g., display unit 125 of FIGS. 1A and 1B. The media content may be primarily textual in nature, e.g., an e-book, in some embodiments. In accordance with embodiments of the present invention, the media content may be any content disposed for presentation on such a device, and may include, for example, audio and/or video programming, still pictures and non-textual images, e.g., graphs, charts, mathematical and/or chemical formulae, and the like.

In 720, information corresponding to other users' interaction with the media content is accessed. For example, a social media may be accessed via a wireless network. In 730, an activity indicator, e.g., activity indicator 220 of FIG. 2, is displayed on the display screen. In accordance with embodiments of the present invention, an activity indicator may indicate a magnitude of a number of such users. In some embodiments, the size, shape, color and/or brightness and the like of an activity indicate may correspond to the number of such users. In some embodiments, an activity indicate may indicate a number of comments relating to the media uploaded to a social media.

In optional 740, additional information related to the other users' interaction with the media content is displayed on the display screen, responsive to a user activation, e.g., touch, of the activity indicator. The additional information may comprise statistics, e.g., as presented in FIG. 3, or comments from other users, e.g., as presented in FIG. 4.

Embodiments in accordance with the present invention provide systems and methods for activity indictors that provide an enhanced user experience to a user. In addition, embodiments in accordance with the present invention provide systems and methods for activity indictors that indicate a magnitude of other users interacting with the same media. Further, embodiments in accordance with the present invention provide systems and methods for activity indictors that are compatible and complementary with existing systems and methods of electronic device operation and usage.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
displaying a media content on a display screen;
accessing information corresponding to other users' interaction with said media content; and
displaying an activity indicator on said display screen,
wherein said activity indicator reflects a magnitude of said other users' interaction with said media content.

2. The method of claim 1 wherein said activity indicator reflects a substantially real time indication of said other users' interaction with said media content.

3. The method of claim 1 wherein said activity indicator reflects a cumulative, non-real time indication of said other users' interaction with said media content.

4. The method of claim 1 wherein a size of said activity indicator is positively correlated to a number of other users interacting with said media content.

5. The method of claim 1 wherein a brightness of said activity indicator is correlated to a number of other users interacting with said media.

6. The method of claim 1 wherein a shape of said activity indicator is correlated to a number of other users interacting with said media.

7. The method of claim 1 further comprising:
responsive to a user activation of said activity indicator, displaying additional information on said display screen related to said other users' interaction with said media content.

8. The method of claim 7 wherein said additional information comprises other users' comments related to said media content.

9. A computer system comprising:
a processor;
a network interface coupled to said processor;
a display screen coupled to said processor;
a memory coupled to said processor and said display screen;
wherein said computer system is configured to:
display a media content on said display screen;
utilizing said network interface, access information corresponding to other users' interaction with said media content; and
display on said display screen an activity indicator on said display screen,
wherein said activity indicator reflects a magnitude of said other users' interaction with said media content.

10. The computer system of claim 9 wherein said computer system is hand held.

11. The computer system of claim 9 wherein said network interface is a wireless interface.

12. The computer system of claim 9 wherein said activity indicator reflects a substantially real time indication of said other users' interaction with said media content.

13. The computer system of claim 9 wherein a size of said activity indicator is correlated to a number of other users interacting with said media content.

14. The computer system of claim 9 wherein said computer system is further configured to:
display additional information on said display screen related to said other users' interaction with said media content, responsive to a user touching said activity indicator.

15. The computer system of claim 14 wherein said additional information comprises other users' comments related to said media content.

16. An article of manufacture including a computer readable medium having instructions stored thereon that, responsive to execution by an electronic system, cause said electronic system to perform operations comprising:
displaying a media content on a display screen of said electronic system;
accessing information corresponding to other users' interaction with said media content; and
displaying an activity indicator on said display screen,
wherein said activity indicator reflects a magnitude of said other users' interaction with said media content.

17. The article of manufacture of claim 16 wherein said activity indicator reflects a substantially real time indication of said other users' interaction with said media content.

18. The article of manufacture of claim 16 wherein said activity indicator reflects a substantially real time indication of said other users' interaction with said media content.

19. The article of manufacture of claim 16 wherein a size of said activity indicator is correlated to a number of comments in a social media related to said media content.

20. The article of manufacture of claim 16 wherein said operations further comprise:
responsive to a user activation of said activity indicator, displaying additional information on said display screen related to said other users' interaction with said media content.
